(19) United States
(12) Patent Application Publication
(10) Pub. No.: US 2016/0244115 A1
(43) Pub. Date: Aug. 25, 2016

(54) Bicycle Cargo Container Support

(71) Applicant: James C. Warren, Costa Mesa, CA (US)

(72) Inventor: James C. Warren, Costa Mesa, CA (US)

(21) Appl. No.: 15/043,504

(22) Filed: Feb. 13, 2016

Related U.S. Application Data
(60) Provisional application No. 62/116,373, filed on Feb. 14, 2015.

(51) Int. Cl. B62J 9/00

(52) U.S. Cl. CPC B62J 9/003

(57) ABSTRACT

A bicycle front basket support that is attached to the front of the frame of an existing traditional bicycle, without any modification to the existing bicycle, and upon which a basket or generic cargo container can be mounted. The support is attached to, and supported by, the frame of the bicycle so that it does not move with the steering. And the assembly is adjustable to fit different sizes and configurations of bicycle frames.

### BACKGROUND

This invention relates to a bicycle front basket support. More specifically, this invention relates to a support that is attached to the front of the frame of an existing traditional bicycle, without any modification to the existing bicycle, and upon which a basket or generic cargo container can be mounted. Typical bicycles are designed around the rider and do not easily facilitate the carrying of large or heavy cargo. There are a few bicycles that are designed specifically to carry cargo, and these are loosely referred to as cargo bicycles.

A standard way to carry items on a bicycle is by using a front basket. Most front bicycle baskets are attached to the handlebars and fork (steering mechanism). This causes instability and difficulty in steering if a moderate or large load is carried. One solution to this problem is to use a special cargo bicycle referred to as a cycle truck. The cycle truck has a special frame that is designed with a cargo platform at the front that is an integral part of the frame, and that uses a smaller front wheel to make room for the platform. The usefulness of cycle trucks has been proven over many years. Another solution is a bicycle with a special frame that contains permanent mounting points for a front basket. These options are not usually appealing to a rider because they require purchasing an additional bicycle and they are often awkward to handle and odd looking. What is needed is a support for a front cargo container, or basket, that takes advantage of the benefits of a cycle-truck-type frame-mounted support but that can be attached to an existing bicycle without modification of the bicycle.

### SUMMARY

The principal object of this invention is to provide a support for a basket or other container at the front of a bicycle with such support attached to, and supported by, the frame of the bicycle so that it does not move with the steering. It also is an object of this invention to provide such a support that can be attached to a traditional bicycle without modification of the bicycle. And finally, another object is to provide such a support that is adjustable to fit different sizes and configurations of bicycle frames.

### BRIEF DESCRIPTION OF THE FIGURES

FIG. 1: For reference and orientation; a typical bicycle with the cargo support of this invention and a wire basket attached.

FIG. 2: Overall view of the cargo support showing the attachment to a typical bicycle.

FIG. 3: Overall view of the cargo support assembly.

FIG. 4: Top view of the cargo support assembly

FIG. 5: Detail exploded view of the main components.

### DETAILED DESCRIPTION OF THE INVENTION

### Preferred Embodiment

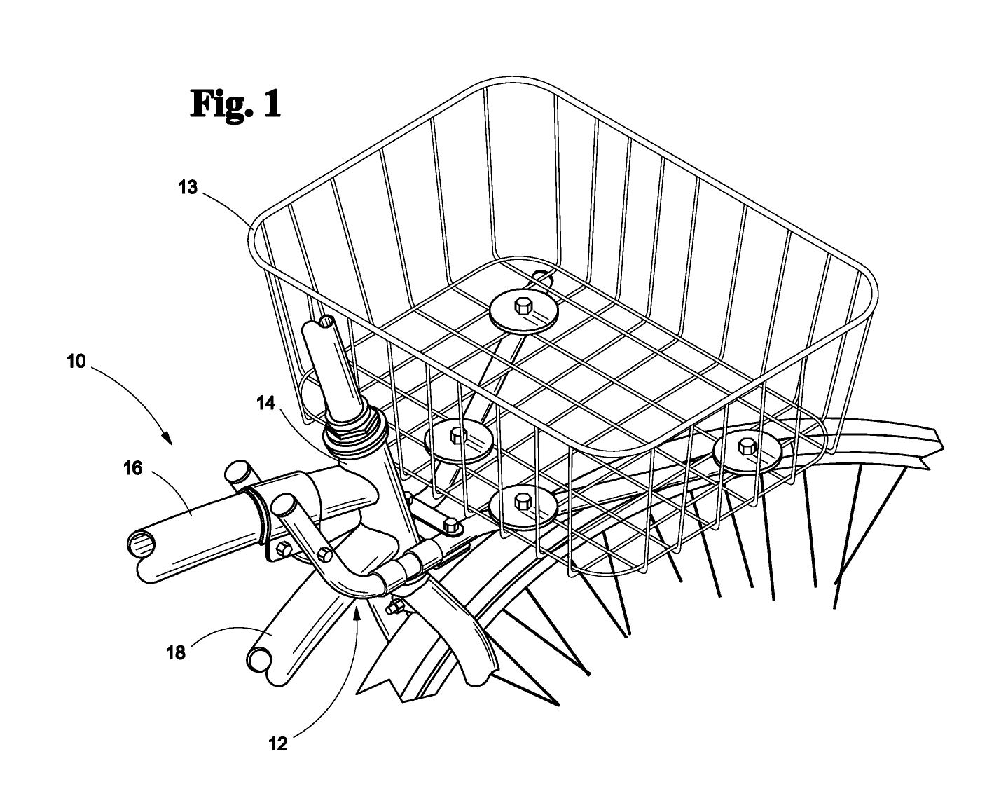

FIG. 1 is a pictorial view of a conventional bicycle 10 having mounted thereon the preferred embodiment of the cargo container support of this invention (indicated generally at 12). Mounted upon the support 12 is a typical wire basket 13 (generic cargo container). Bicycle 10 includes a frame; the forward portion of which is conventionally made up of a head tube 14, a top tube 16, and a down tube 18.

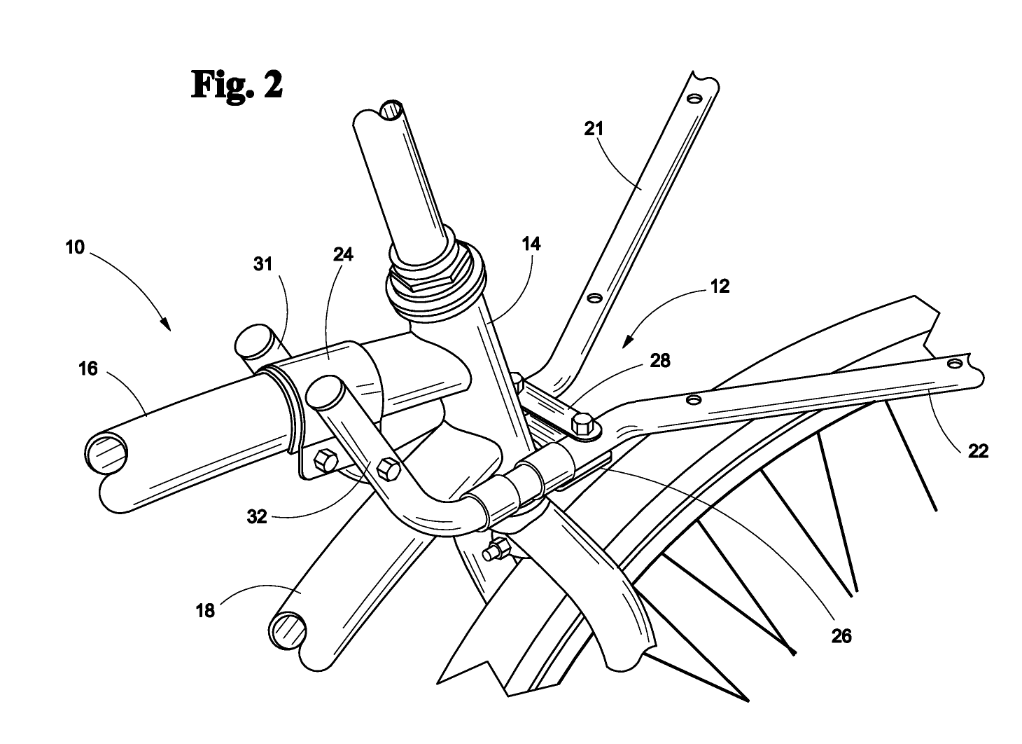

The cargo container support is comprised of five major parts. FIGS. 2 & 3 show these parts to be a left support 21, a right support 22, a frame clamp 24 positioned on the top tube 16 of the bicycle, a head tube plate 26, and a head tube washer 28. The left and right supports 21 & 22 are mounted and connected at their upper end at the frame camp 24. The head tube plate 26 and washer 28 together connect the left and right supports 21 & 22 at the front of the head tube 14 of the bicycle.

FIG. 2 shows the cargo container support components in their assembled positions on a bicycle. The left and right supports 21 & 22 are bent from metal tubing of about ⅝″ diameter to form a fork shape when viewed together from above. The spreading apart of the supports as they extend horizontally forward of the frame and above the front wheel provides a stable platform for mounting a cargo container. The rear portion of each support is bent up at approximately 70 deg. from horizontal to form uprights 31 & 32 that are generally parallel to the axis of the head tube 14 of the bicycle frame. The left and right supports 21 & 22 contain horizontal mounting holes in the uprights 31 & 32 to facilitate assembly to the frame clamp 24 and vertical mounting holes near the front of the head tube 14 to facilitate assembly to the head tube plate 26 and washer 28. The forward “forked” portion of the supports contain vertical mounting holes to facilitate the mounting of a cargo container. These mounting holes can be seen best in FIG. 4.

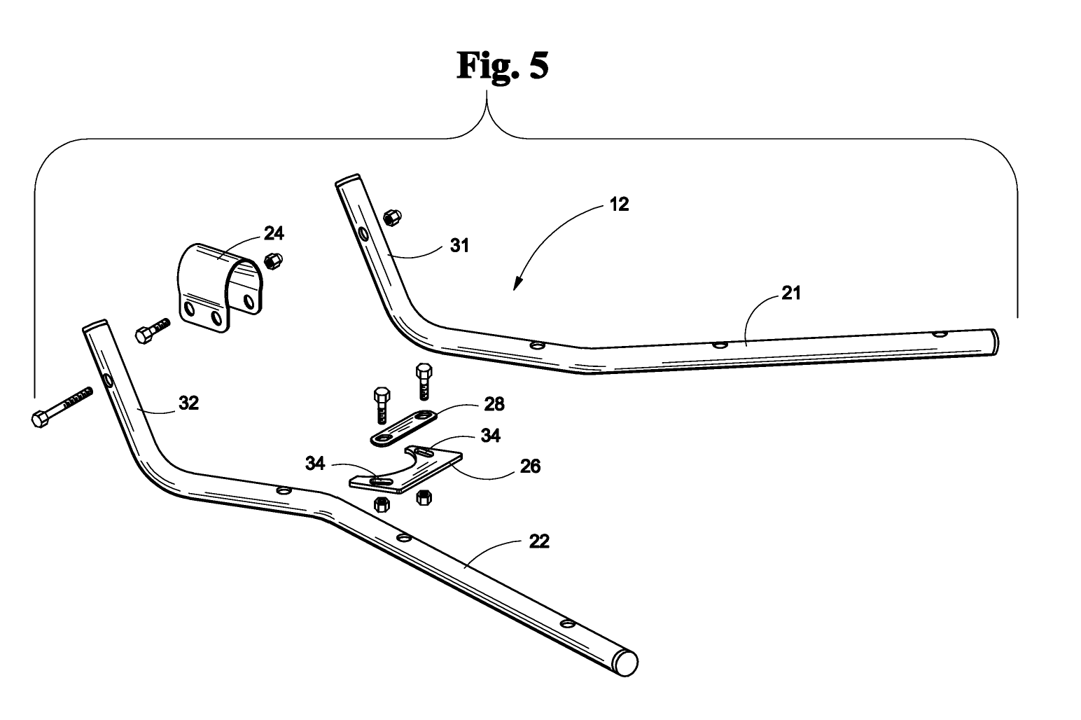

As shown in FIG. 2, the frame clamp 24 is bent from a rectangular piece of sheet metal. It forms a horseshoe shape with projecting ends that have two sets of holes to receive a bolt to tighten the clamp on the top tube 16 and a bolt to attach, connect, and support the left and right supports 21 & 22. The frame clamp 24 is made from sheet metal that is just flexible enough so that it can snap over and fit different size frame tubes. The frame clamp 24 is proportioned so that it is at least as wide (along the length of the frame) as the diameter of the frame tube it is clamping. This design, along with the stiffness of the sheet metal, helps to resist any twisting motion of the whole assembly. The details of the frame clamp 24 can be seen best in FIG. 5.

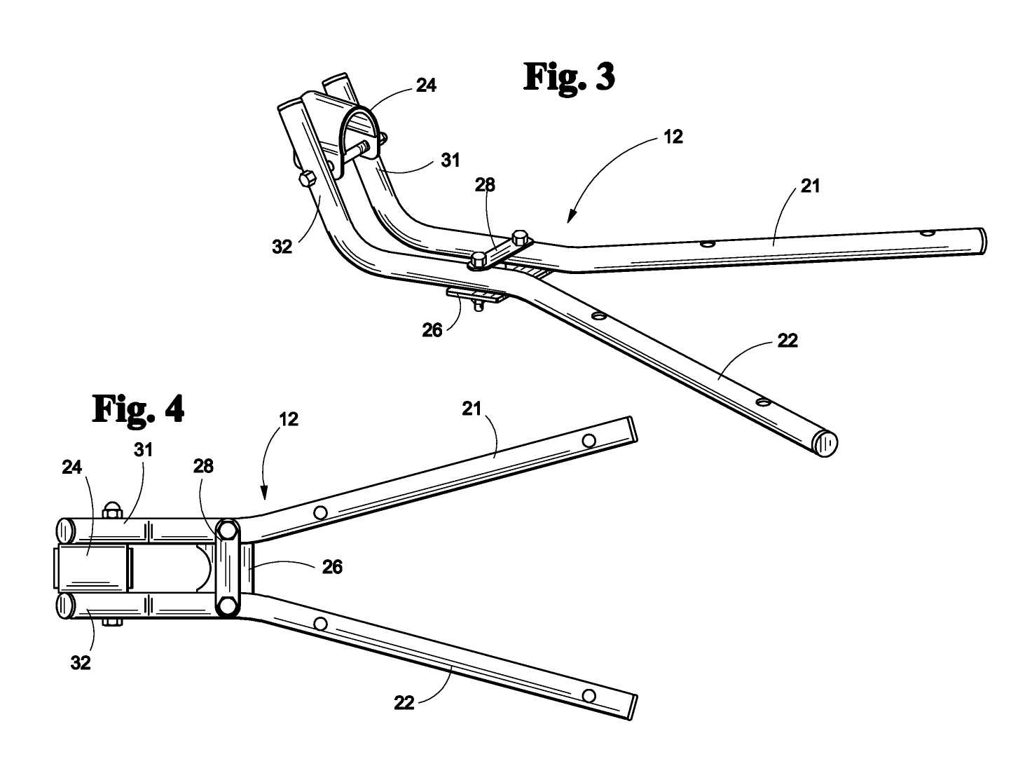

The head tube plate 26 is a flat metal plate which is generally rectangular with rounded corners but with one of the longer sides being concave with a radius of curvature slightly larger than the curvature of the head tube 14. This concave edge rests and braces against the front of the head tube 14. As seen more clearly in FIG. 5, the head tube plate 26 contains angled slots 34 to receive bolts to connect the left and right supports 21 & 22. These slots 34 allow for adjustment of the distance between the left and right supports 21 & 22 so that they fit tightly to the sides of the head tube 14 when assembled to frames of various sizes. The slots 34 are angled so that slipping and widening of the connection is resisted by the bolts against the side of the slots. The thickness of the head tube plate is such that it is stiff enough to resist twisting or turning of the left and right supports 21 & 22. The stiffness of this assembly is further enhanced by the head tube washer 28 which is assembled under the heads of the bolts connecting the left and right supports 21 & 22 through the head tube plate 26, but on the opposite side of the supports. This results in the left and right supports 21 & 22 being sandwiched and clamped between the head tube plate 26 and head tube washer 28 and held tight with the two bolt and nut assemblies as shown most clearly in FIG. 3. The head tube washer 28 is flat sheet metal with an elongated oval shape and slotted holes at each end to accommodate the width adjustment of the head tube plate 26.

To assemble and attach the cargo container support 12 onto bicycle 10, frame clamp 24 is slipped over the top tube 12 and loosely secured with a bolt and nut through one of the pairs of holes. The left and right supports 21 & 22 are then assembled with the head tube plate 26 and head tube washer 28 by fastening two bolt and nut assemblies through the washer slots, then through the corresponding vertical mounting holes in the mid-section of the supports, and finally through the plate slots. The head tube plate 26 is oriented in this assembly with the curved side facing, resting upon, and braced against the front of the head tube 14. The bolts are moved along the slots until the supports fit tight against the sides of the head tube, and then they are tightened to hold this position. The nuts used are of a ridged, locking, non-slip type to prevent movement. This whole assembly is placed around the front and sides of the lower section of the head tube 14 with the mid-section and “forked” forward section of the left and right supports 21 & 22 approximately horizontal. Next, frame clamp 24 is moved along top tube 16 to line up with the mounting holes in support uprights 31 & 32 , and it is secured by tightening the already assembled bolt and nut. Finally, a long bolt is passed through the mounting holes in both support uprights 31 & 32 and, in the middle, through the open mounting holes in frame clamp 24 and secured with a nut. The bolts securing the head tube plate are tightened to final torque to prevent slipping, and then the long bolt through the supports and frame clamp is tightened. When this final tightening is done, the left and right supports 21 & 22 are brought into firm contact with the surfaces of the head tube 14 and down tube 18 of the bicycle frame and the outer surface of the frame clamp 24. This tightening effectively clamps the bicycle frame between the left and right supports. This procedure does not require any modification of the existing bicycle and will work with different frame configurations (i.e. male and female styles) and sizes.

Any basket, box, or container with a rigid bottom (not part of this patent) is mounted on top of the forward, approximately horizontal, and “forked” portion of the left and right supports 21 & 22 using the vertical mounting holes (as seen in FIG. 1). The load of this container, and any cargo carried in it, is supported mostly by the connection at the frame clamp with a smaller portion supported by the interface of the head tube plate with the front of the head tube. The sideways and twisting movement of any cargo is resisted by the clamping of the bicycle frame between the left and right supports at the head, down, and top tubes.

The following details are not discussed in the above description for the purpose of clarity, but they can be seen clearly in the figures. These details are of a protective and/or cosmetic nature: At all points where the invention contacts the existing bicycle frame, protective, non-marring, padding is used to protect the frame. This padding is usually made from some type of plastic or rubber material. These pads include a thin sheet at the inner diameter of the frame clamp 24, round tubes or sheets at points where the supports 21 & 22 contact the down tube 18 and the head tube 14, and edging where the head tube plate 26 rests against the head tube 14. Also, an acorn nut, or other cap, is used on the end of the long bolt that fastens the left and right supports 21 & 22 to the frame clamp 24 to prevent injury to the rider. Finally, end plugs or caps are installed at the four ends of the left and right supports 21 & 22 to prevent injury, seal from water and debris, and give a finished appearance.

### Alternate Embodiments

Various alternate embodiments of this invention could be made. The length of the left and right supports could be varied and additional mounting holes could be added to enhance the fit adjustability for different sizes and configurations of bicycle frames. The left and right supports could be made from various shapes and sizes of tubing including round, square, rectangular, and oval. This tubing could also be made from non-metallic materials such as reinforced plastics. The left and right supports could also be made as stamped and formed metal plates.

In addition, the attachment of the invention to the bicycle frame could be varied. The frame clamp could be placed on the down tube, or multiple clamps could be utilized. Also the head tube plate and washer could be made in a different shape or of a different material.

### CONCLUSION

In view of the above description the reader can see that the invention provides a support for a basket or other cargo container at the front of the bicycle. It is seen that the invention is attached to, and supported by, the frame of the bicycle so that it does not move with the steering of the bicycle. It is also seen that the invention is attached to a traditional bicycle without modification of the bicycle. And finally, it is seen that the invention is adjustable to fit different sizes and configurations of bicycle frames.

The forgoing description of the preferred embodiment and various alternate embodiments of the invention have been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A bicycle cargo container support for attachment and use on the front of an existing bicycle comprising:
a) a frame clamp that is shaped, and is adjustable, to fit over and clamp a bicycle frame tube and provide a mounting and connection point for the upper end of
b) left and right supports that are shaped so that they contact the bicycle frame on the left and right side respectively and then extend horizontally forward of the frame and above the front wheel to provide a mounting platform for a cargo container,
c) an adjustable head tube plate and head tube washer that connect and brace the left and right supports at the front side of the bicycle frame head tube.

2. The bicycle cargo container support of claim 1 wherein the supports are attached to the frame of the bicycle, and not the steering mechanism (handlebars and/or fork) of the bicycle, such that the load of the container and cargo is supported by the frame of the bicycle.

3. The bicycle cargo container support of claim 2 wherein said support is attached to the bicycle without requiring modification of the bicycle.

4. The bicycle cargo container support of claim 2 wherein said left and right supports clamp the existing bicycle frame between them to resist sideways and twisting movement of a mounted container and cargo.

5. The bicycle cargo container support of claim 2 wherein the support structure is adjustable to various sizes and configurations of bicycle frames.

6. The bicycle cargo container support of claim 1 wherein said supports provide a generic, approximately horizontal, mounting platform for a basket, box, tray, or other cargo carrying container that has a rigid bottom or base.

7. The bicycle cargo container support of claim 1 wherein said bicycle is a traditional bicycle, electric or gas motor powered bicycle, moped, scooter, or motorcycle.
